(19) United States
(12) Patent Application Publication
(10) Pub. No.: US 2013/0291852 A1
(43) Pub. Date: Nov. 7, 2013

(54) INTEGRATED GALLEY WITH IMPROVED HEATING SYSTEMS

(71) Applicant: MAG AEROSPACE INDUSTRIES, INC., Carson, CA (US)

(72) Inventor: Abdelaziz Boubeddi, Ashburn, VA (US)

(73) Assignee: MAG AEROSPACE INDUSTRIES, INC., Carson, CA (US)

(21) Appl. No.: 13/873,383

(22) Filed: Apr. 30, 2013

Related U.S. Application Data
(60) Provisional application No. 61/642,141, filed on May 3, 2012.

(51) Int. Cl. A47J 39/00; B64D 11/04

(52) U.S. Cl. CPC A47J 39/006; B64D 11/04
USPC 126/20

(57) ABSTRACT

Embodiments of the present invention provide improved heating systems for aircraft galleys and other passenger transport vehicles, where meals are prepared. The embodiments are particularly designed to save space and in some instances, may lower the weight of the overall vehicle, by moving heat generating components to a position remote from the cooking cavity.

### CROSS REFERENCE TO RELATED APPLICATIONS

This application claims the benefit of U.S. Provisional Application Ser. No. 61/642,141, filed May 3, 2012, titled “Integrated Galley,” the entire contents of which are hereby incorporated by reference.

### FIELD OF THE INVENTION

Embodiments of the present invention relate generally to integrated aircraft galleys that provide increased storage and counter space by incorporating improved meal heating systems in the galley area, without requiring changes in the existing aircraft catering processes for loading and serving meals.

### BACKGROUND

Aircraft galleys are different from traditional cooking kitchens, in that space is very limited and weight reduction is a high priority. Similar situations exist on private yachts, cruise ships, and other sea-going vessels, as well as motor homes, passenger trains, and other types of passenger transportation vehicles. Nonetheless, there are still instances when food preparation is necessary, and a high quality food product is expected.

In many aircraft (and other passenger transportation vehicle) galleys, it is useful to provide an oven that cooks or heats food products. These ovens may be bun warmers, microwaves, steam ovens, convection ovens, traditional ovens, and/or heating ovens with warming coils or plates, as well as any other types of heating systems, all of which are collectively referred to herein as “heating systems.” Use of such heating systems on-board aircraft or other transportation vehicles provides a quick, safe, and convenient method for cooking, heating, or re-heating various types of food products and meals.

However, providing one or more of these complete heating systems in the limited galley space area takes up valuable countertop space. Particularly if more than one heating system is required or if more than one type of heating system is installed in the galley, then each heating system has its own heat generator (typically at the back thereof), which takes up additional space. The heat generators may also be redundant, pulling additional power from the aircraft. Accordingly, improved heating solutions are needed for small spaces, such as aircraft galleys, where weight and space considerations are important. It is desirable that such solutions provide more integrated and efficient heating solutions.

### BRIEF SUMMARY

Embodiments of the present invention provide improved heating systems for aircraft galleys and other passenger transport vehicles, where meals are prepared. The embodiments are particularly designed to save space and in some instances, may lower the weight of the overall vehicle, by moving (and in some instances, consolidating) heat generating components to a position remote from the cooking cavity. In some embodiments, the heat generating components are positioned in or near the cabin galley ceiling; in other embodiments, the heat generating components may be positioned in other locations on the vehicle. The cooking cavity is fluidly connected to one or more of the heating generating components via a ducting system, so that heat and/or steam can be delivered to the cooking cavity.

### BRIEF DESCRIPTION OF THE DRAWINGS

FIG. 1 shows a front and side plan top plan view of one embodiment of a preparation galley in an aircraft.

FIG. 2 shows a front and side plan view of one embodiment of a high density galley in an aircraft.

FIG. 3 shows back perspective views of various embodiments of an aircraft galley wall having a remotely-located heat generator delivering heat to the cooking cavity via heating supply ducting.

FIG. 4 shows a side perspective view of one embodiment of a cooking cavity.

FIG. 5 shows a side perspective view of one embodiment of a meal carrier for use in connection with cooking cavity.

FIG. 6 shows a side perspective view of one embodiment of a standard container for use in an aircraft galley.

FIG. 7 shows a side perspective view of one embodiment of a standard trolley for use in an aircraft galley.

FIG. 8 shows a side perspective view of one embodiment of an aircraft galley with multiple heat generators positioned in dead space corner areas.

FIG. 9 shows a front plan view of multiple cooking cavities with doors closed.

FIG. 10 shows a front plan view of FIG. 9 with the cavity doors removed.

### DETAILED DESCRIPTION

Embodiments of the invention described herein thus provide a cooking cavity 12 (or cavities) that is (are) positioned remotely from the heat generator portion(s) 16. (The term “cooking cavity” is used herein to refer to an internal portion of an oven or a heating device, and generally includes an insulated liner only, and does not include any of the other heating components that are traditionally associated with an oven or heating unit.) The cooking cavity may be formed as a vacuum insulated stainless steel liner, with an insulating material surrounding the liner, and an outing casing. One example of a cooking cavity is shown in FIG. 4. In a specific embodiment, the cooking cavity is designed to contain one or more meal carriers 14 (an example of which is shown in FIG. 5), which contain meals for consumption on-board the vehicle. During the catering process, the meal carriers are generally loaded directly into the cooking cavity when the cavity is not warmed or heated. When the catering process is to begin, heat from the heat generator is directed toward the cooking cavity.

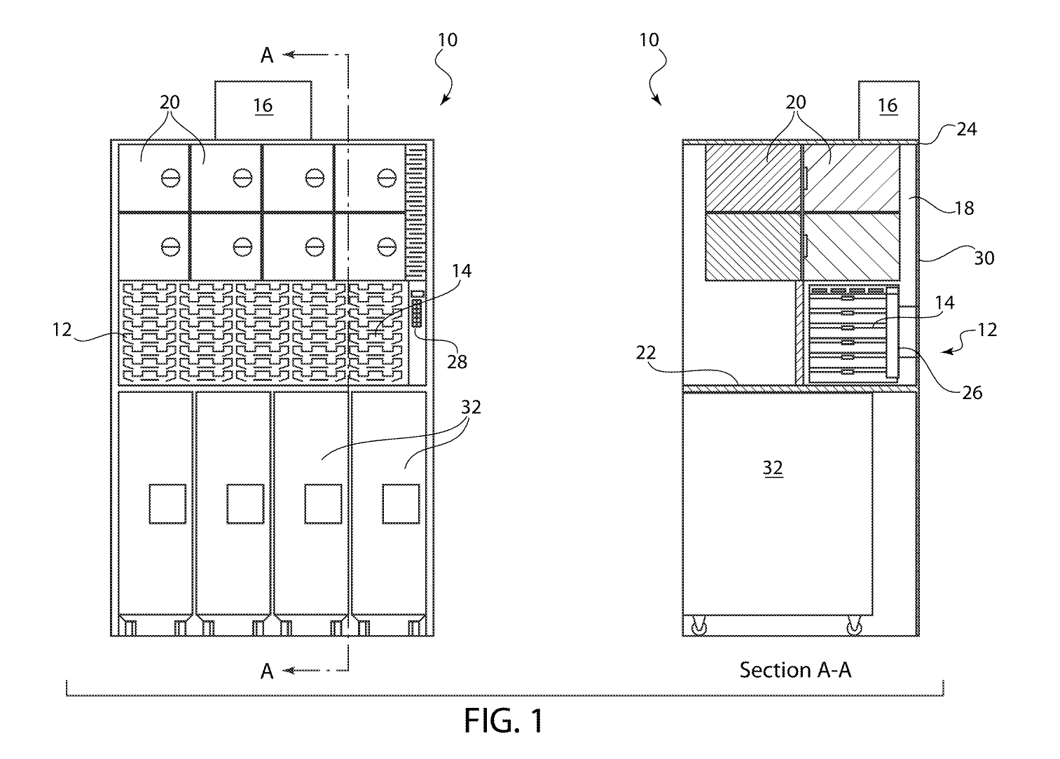

As shown in FIG. 1, which illustrates an aircraft preparation galley 10, a cooking cavity 12 is generally positioned at countertop level. This figure shows the cavity 12 having a plurality of meal carriers 14 positioned therein. A traditional oven or other heating system would require a large amount of counter space due to the heating components associated with the oven, which are typically positioned at the back of the oven. However, the present inventors have moved all functioning and other components of the heating system away from the countertop area, and positioned them remotely from the cooking cavity 10. For example, the heat generator 16 is positioned at an upper area of the galley 10. (The term “heat generator” is used herein to refer to any of the heating components or elements that are used to generate heat and/or steam for cooking, heating, and/or re-heating food items or meals. The term includes but is not limited to heating coils, blowers, steam generators, power supplies, any other appropriate heat generating components, or any combination thereof.) It is also possible for the systems described herein to be implemented in connection with a cooling system for a refrigerator or other cooling unit.

It is possible to provide one or more of a convection heat generator, an induction heater, a steam heat generator, a radiation heat generator, or any other combination of heat generators desired. A single heat generator may be provided (which may be used to deliver heat to a single or multiple cooking cavities) or multiple heat generators may be provided to deliver various different types of heat or additional forms of the same type of heat to one or more cooking cavities. It is also possible to provide one or more universal heat generators designed to create various types of heat desired in a single unit. It is also possible to provide a cooling unit or one or more universal cooling generators designed to create various types of cooled air as well.

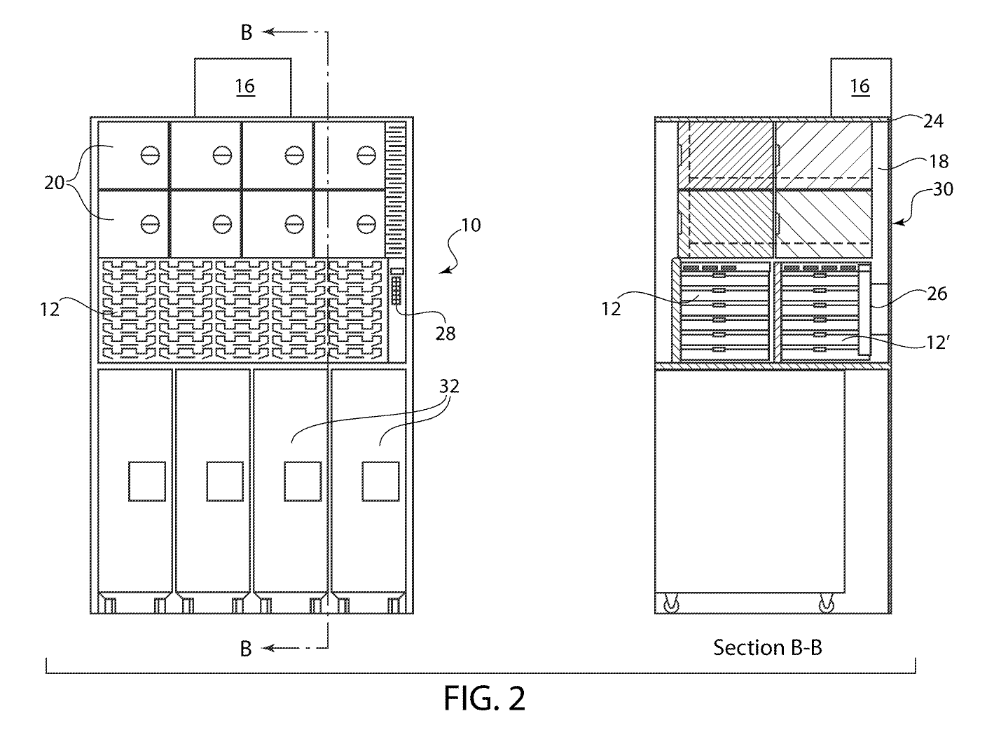

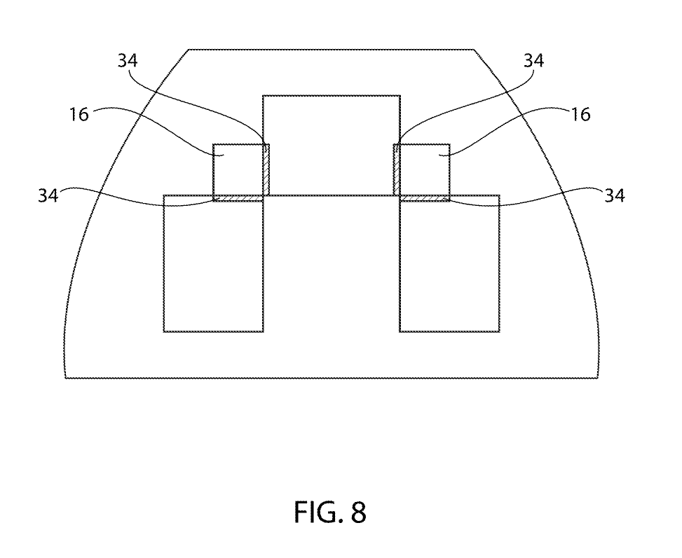

Instead of being positioned above the galley cabinet area as shown in FIGS. 1 and 2, the heat generator(s) 16 may alternatively be positioned in an alternate space, such as in the space allotted for one or more of the containers 20, in one of the lower trolleys 32, in a dead area of the galley, such as one or more of the corners which are typically unused, in one of the closets, or any other area where there is unused or dead space in the galley or in the aircraft. In fact, it is possible to locate the heat generator(s) 16 even further from the galley, or any other desired area, as long as the ducting is sufficiently long and sufficiently insulated to deliver the heat to the cooking cavity 12. One example of a heat generator 16 positioned in a corner cavity of a galley area is shown by FIG. 8. Access to the heating generator unit 16 is provided at one or more points 34 behind or beneath the heating unit 16.

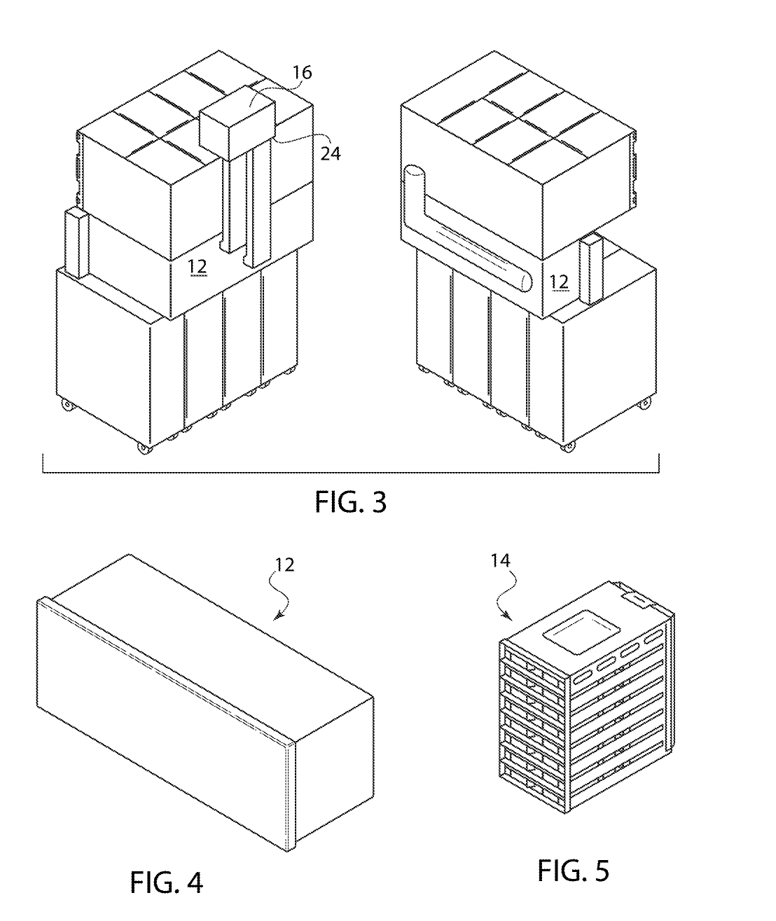

The heat generator 16 is generally associated with heating supply insulated ducting 18 that is used to deliver the generated heat to the cooking cavity 12. Examples of various configurations of heating supply ducting are shown in FIG. 3, and may depend upon whether one or more cooking cavities 12 are being supplied with heat. Ducting 18 allows the heat generator 16 to be located in a remote location, i.e., away from the cooking cavity 12 and not directly connected thereto or associated therewith, but to deliver the heat generated at the remote location to the cooking cavity 12 for warming/heating/cooking. The heating supply ducting 18 may be secured to the heat generator 16 and the cooking cavity 12 via any appropriate connection method. It generally provides a channel to conduct and deliver heat and/or steam. The heating supply ducting 18 may be manufactured out of an insulated ducting material.

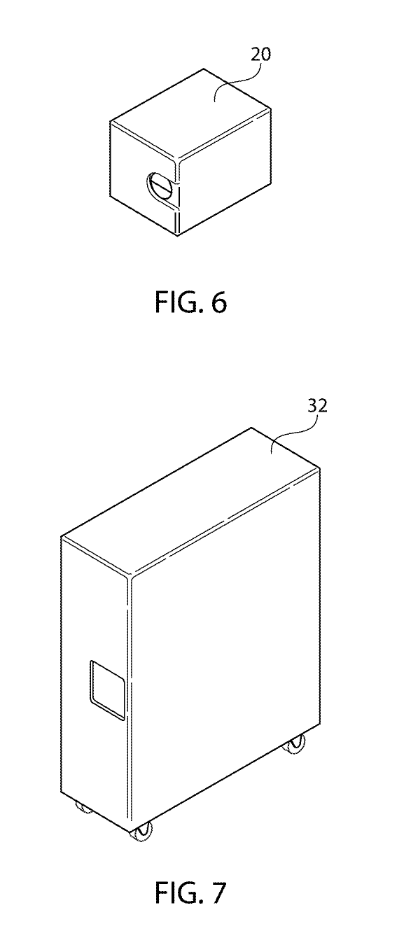

FIG. 1 illustrates a heat generator 16 positioned above a set of containers 20. These containers may generally be standard Atlas containers, and they are used for storage and containing items in an aircraft galley, much like traditional cabinets. One example of a particular container is shown in FIG. 6. The space above these containers 20 in a traditional galley generally goes unused, so by re-positioning the heat generator 16 to this location, additional space can be garnered, for example, for additional countertop space 22 and additional cabinets 20. This additional countertop space 22 and cabinet space is created by moving the heat generator to the remote location. The Section A-A of FIG. 1 and Section B-B of FIG. 2 illustrate the ducting 18 that leaves the heat generator 16 at a heat generator connection point 24, travels along a back wall of the galley 30, and delivers the heat and/or steam to the cooking cavity 12 via a cooking cavity inlet/connection point 26.

Space is also maximized in the current design because the cooking cavity does not need as much clearance around it (for safety reasons and regulations), because the heat is being generated remotely. The remotely-located heat generator 16 may need the appropriate clearances for cooling and air circulation, but this does not take up valuable space at the galley countertop level. This system also eliminates the required clearances and keeps only the inner cavity (the insulated cooing cavity portion) in the central galley area, which results in freeing galley space that can be used for more cooking and storage space. Additionally, as a result, space in the aircraft cabin can be saved by eliminating, for example, up to even one galley, depending of the size of the aircraft.

When the oven is to be used, the central oven controller 28 is activated to the desired setting. (The provided settings will generally be the traditional oven settings available, such as warm, steam, bake, convection, roast, broil, and so forth). Activation of the controller 28 causes the heat generator 16 to begin generating heat, which may be in the form of hot air and/or steam which is directed to the cooking cavity 12 via the ducting 18. The individual meals in the meal carriers (one example of which is shown in FIG. 5) are then heated to the desired temperature for serving.

In an alternate or additional embodiment, the heat generator 16 may include an insulated water hose that connects the heat generator 16 with a beverage maker. This allows the heat generator to heat water that can be delivered to the beverage maker, such that the beverage maker can similarly pull heat from the remote location, saving space and possibly saving energy. In this embodiment, there may be a water reservoir provided near the heat generator 16 in the remote location to either deliver water to the heat generator and/or to contain heated water.

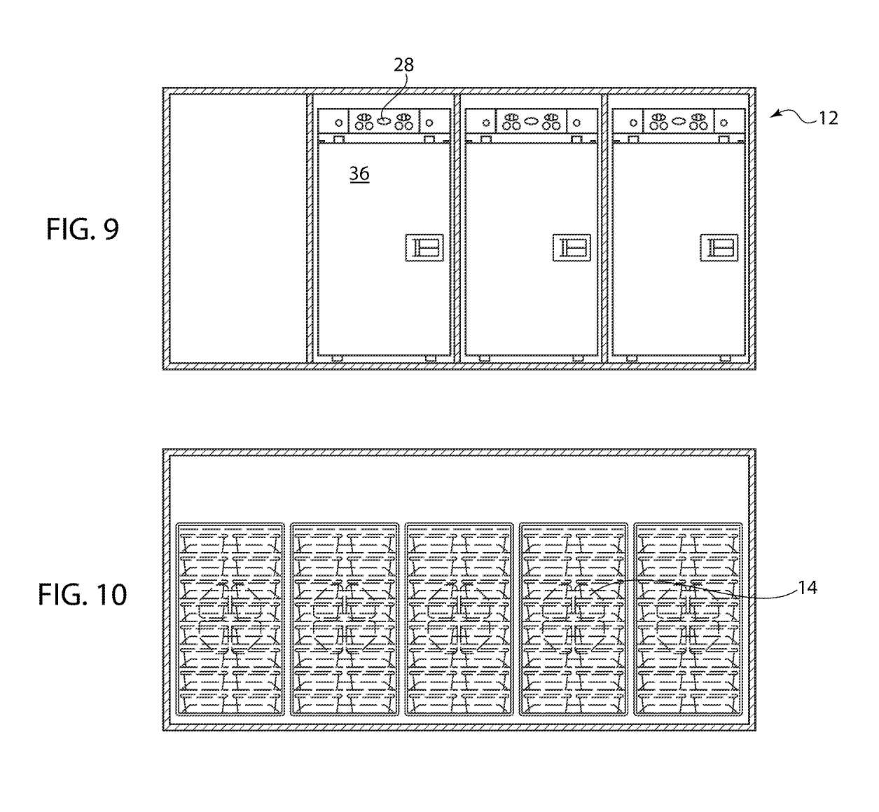

FIG. 2 shows an alternate configuration, with two sets of cooking cavities 12 and 12′ positioned in a high density galley. This galley configuration is possible when countertop space is not needed or is otherwise provided elsewhere. This configuration can allow twice as many meals to be cooked. FIGS. 9 and 10 also illustrate a high density galley with more than one cooking cavity 12. FIG. 9 illustrates the cavities with oven doors 36 closed, and FIG. 10 illustrates the same configuration with the oven doors removed and with meal carriers 14 in place in the cavities 12. Again, by providing the heat generator 16 at a remote location, more cooking cavities may be positioned at the countertop level. Although two cooking cavities are shown in FIG. 2, it should be understood that more cavities may be provided, either stacked upon one another or in a side-by-side configuration (as shown by FIGS. 9-10). The multiple cooking cavities 12 may pull heat from a single heat generator 16 or from more than one heat generators as needed.

FIGS. 1-2 and 7 also illustrate the trolleys 32 that are generally positioned below the countertop area in the galley. These trolleys 32 are particularly useful on longer flights, where a first set of meals is loaded in to the cooking cavity 12 and a second set of meals may be loaded into the trolleys 32 for a second meal consumption many hours later. (Trolleys may also contain other components such as trash compactors or other trash collections areas; they may be drink or snack trolleys, or may be used for any other service cart usage.)

Changes and modifications, additions and deletions may be made to the structures and methods recited above and shown in the drawings without departing from the scope or spirit of the invention and the following claims.

What is claimed is:

1. A heating system, comprising:
A cooking cavity;
A heat generator positioned remotely from the cooking cavity;
A ducting system fluidly connecting the cooking cavity and the heat generator in order to deliver generated heat to the cooking cavity.

2. The heating system of claim 1, wherein the heating system is installed in an aircraft cabin galley.

3. The heating system of claim 1, wherein the heating system is installed in an aircraft cabin galley and wherein the heat generator is positioned in an empty space above galley components.

4. The heating system of claim 1, wherein the heat generator comprises a heater, a blower, a steam generator, a power supply, or any combination thereof.

5. The heating system of claim 1, wherein the ducting system comprises insulated heating supply ducting for heat and steam transfer.

6. The heating system of claim 1, wherein the cooking cavity is a double-walled vacuum insulated cooking cavity.

7. The heating system of claim 1, wherein the cooking cavity is configured to receive one or more aircraft meal carriers.

8. The heating system of claim 1, wherein the heating system does not require any changes to current catering processes.

9. A heating system configured for installation in an aircraft cabin galley, comprising:
A cooking cavity configured to receive one or more aircraft meal carriers;
A heat generator positioned above galley components and remotely from the cooking cavity;
A ducting system comprising insulated heating supply ducting for heat and steam transfer fluidly connecting the cooking cavity and the heat generator in order to deliver generated heat to the cooking cavity.

10. The heating system of claim 9, wherein the heat generator comprises a heater, a blower, a steam generator, a power supply, or any combination thereof.

11. The heating system of claim 9, further comprising an insulated hot water hose connecting the heat generator with a beverage maker.

12. The heating system of claim 9, wherein the cooking cavity is a double-walled vacuum insulated cooking cavity.

13. The heating system of claim 9, wherein the heating system does not require any changes to current aircraft catering processes.
